(19) United States
(12) Patent Application Publication
(10) Pub. No.: US 2006/0003772 A1
(43) Pub. Date: Jan. 5, 2006

(54) Method and system for establishing a voice call for a hybrid mobile station operating in a data mode

(75) Inventor: William J. Semper, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/115,486

(22) Filed: Apr. 27, 2005

Related U.S. Application Data
(60) Provisional application No. 60/584,937, filed on Jul. 1, 2004.

(51) Int. Cl. H04Q 7/20

(52) U.S. Cl. 455/452.1; 455/426.1; 455/458; 455/552.1

(57) ABSTRACT

A method for establishing a voice call for a hybrid mobile station that is initially operating in a data mode is provided. The method includes receiving an incoming voice call for the hybrid mobile station. A single Paging Request message is transmitted based on the incoming voice call. A Connection Management Service Request message is received. The voice call is established for the hybrid mobile station based on the Connection Management Service Request.

### CROSS-REFERENCE TO RELATED APPLICATION AND CLAIM OF PRIORITY

The present invention is related to that disclosed in U.S. Provisional Patent No. 60/584,937, filed Jul. 1, 2004, entitled “Method for Cross-Paging Between CDMA2000 and HRPD Systems.” U.S. Provisional Patent No. 60/584,937 is assigned to the assignee of the present application. The subject matter disclosed in U.S. Provisional Patent No. 60/584,937 is hereby incorporated by reference into the present disclosure as if fully set forth herein. The present application hereby claims priority under 35 U.S.C. §119(e) to U.S. Provisional Patent No. 60/584,937.

### TECHNICAL FIELD OF THE INVENTION

The present invention relates generally to wireless networks and, more specifically, to a method and system for establishing a voice call for a hybrid mobile station operating in a data mode.

### BACKGROUND OF THE INVENTION

The use of cellular telephones and wireless networks has become increasingly widespread. As the use of cellular telephones has increased, the number and quality of additional features made available with the cellular telephones has also increased. For example, some mobile stations (e.g., cellular telephones) are able to provide hybrid services by allowing users to participate in either voice calls or data sessions. In this way, a single, hybrid mobile station may provide the functionality of both a cell phone and a device that is operable to send and receive e-mail, text messages, or the like over a data network.

When the hybrid mobile station is in a data mode and a voice call for the mobile station is received at a corresponding mobile switching center (MSC), the MSC has to notify the mobile station of the incoming voice call so that the mobile station may switch over to a voice mode and the call may be established. Conventional techniques for establishing a call in this situation include the MSC sending a Page Request message to the base station handling the data session for the mobile station and also sending Page Request messages to any base stations that may be near the mobile station and are able to handle the call session. The MSC also notifies the call session base station not to page the mobile station because the mobile station is operating on a frequency different from the frequency used by the data session base station.

The call session base stations then wait for a possible Page Response from the mobile station. At the same time, the data session base station is paging the mobile station, which eventually responds to both the data session base station and one of the call session base stations. This call session base station receives the Page Response and proceeds to set up the voice call using a messaging standard, such as TIA-2001.

Thus, because the MSC does not know which call session base station the mobile station will select for the voice call, the MSC must transmit an excessive number of paging messages. In addition, conventional techniques for switching a mobile station from a data session to a call session require a relatively complex implementation of call session base stations because the base stations must have two paging algorithms: one for when the MSC actually wants the base station to send a Page Request over the air to look for a mobile station and one for the cross-paging case where the base station would not send a Page Request over the air, but would instead wait for the mobile station to respond to a Page Request sent from a data session base station.

Therefore, there is a need in the art for improved wireless networks that reduce the number of superfluous paging messages for switching mobile stations from data sessions to call sessions and that reduce the complexity of base stations. In particular, there is a need for a wireless network that is able to establish a voice call for a hybrid mobile station that is operating in a data mode without superfluous paging messages and without adding complexity to the base stations.

### SUMMARY OF THE INVENTION

In accordance with the present invention, a method and system for establishing a voice call for a hybrid mobile station that is operating in a data mode are provided that substantially eliminate or reduce disadvantages and problems associated with conventional methods and systems.

To address the above-discussed deficiencies of the prior art, it is a primary object of the present invention to provide a method for establishing a voice call for a hybrid mobile station that is initially operating in a data mode. According to an advantageous embodiment of the present invention, the method comprises receiving an incoming voice call for the hybrid mobile station. A single Paging Request message is transmitted based on the incoming voice call. A Connection Management (CM) Service Request message is received. The voice call is established for the hybrid mobile station based on the CM Service Request.

According to one embodiment of the present invention, the single Paging Request message is transmitted to a data session base station that the hybrid mobile station is initially accessing in a data session.

According to another embodiment of the present invention, the data session base station is capable of operating in a High Rate Packet Data environment.

According to still another embodiment of the present invention, no messages are transmitted to a call session base station before the CM Service Request message is received.

According to yet another embodiment of the present invention, the CM Service Request message is received from a call session base station and the voice call is established for the hybrid mobile station through the call session base station.

According to a further embodiment of the present invention, the call session base station comprises a hybrid base station, the single Paging Request message is transmitted based on the incoming voice call to the hybrid base station, and the hybrid mobile station is initially accessing the hybrid base station in a data session.

According to a still further embodiment of the present invention, the call session base station is capable of operating in a CDMA2000 environment.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network that is capable of establishing a voice call for a hybrid mobile station that is operating in a data mode according to the principles of the present invention;

FIG. 2 illustrates an exemplary hybrid mobile station that is capable of switching from a data mode to a voice mode in order to receive an incoming voice call according to the principles of the present invention; and

FIG. 3 is a flow diagram illustrating a voice call set-up operation according to one embodiment of the present invention.

### DETAILED DESCRIPTION OF THE INVENTION

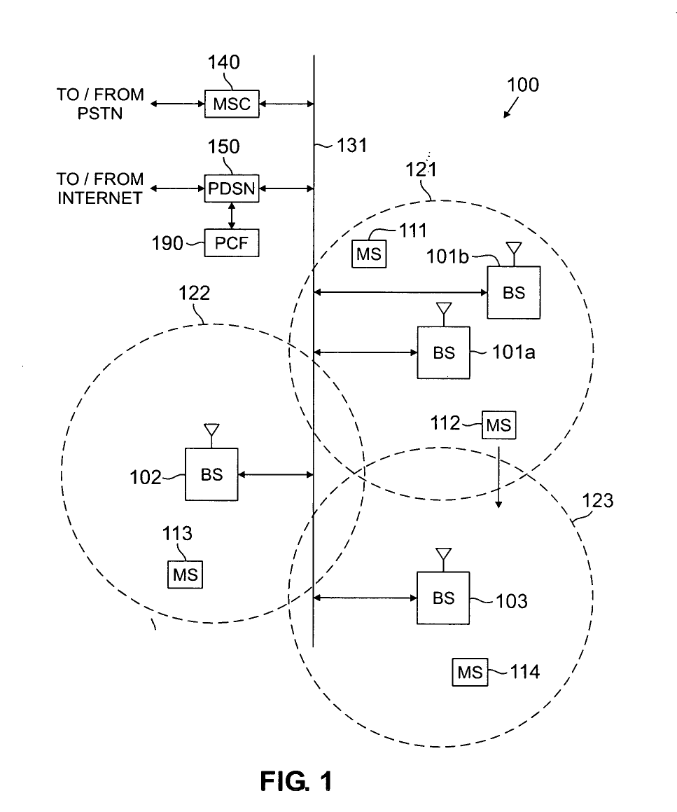

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates an exemplary wireless network 100 that is capable of establishing a voice call for a hybrid mobile station that is operating in a data mode according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101a-b, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101a-b, BS 102 and BS 103, respectively.

BS 101a-b, BS 102 and BS 103 transfer voice and data signals between each other and the public switched telephone network (PSTN) (not shown) via communication line 131 and mobile switching center (MSC) 140. BS 101a-b, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101a-b, BS 102 and BS 103 that establish connections for voice and data circuits between MSC 140 and BS 101a-b, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101a-b, BS 102, or BS 103 to MSC 140.

In the exemplary wireless network 100, MS 111 is located in cell site 121 and is in communication with BS 101a or BS 101b. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

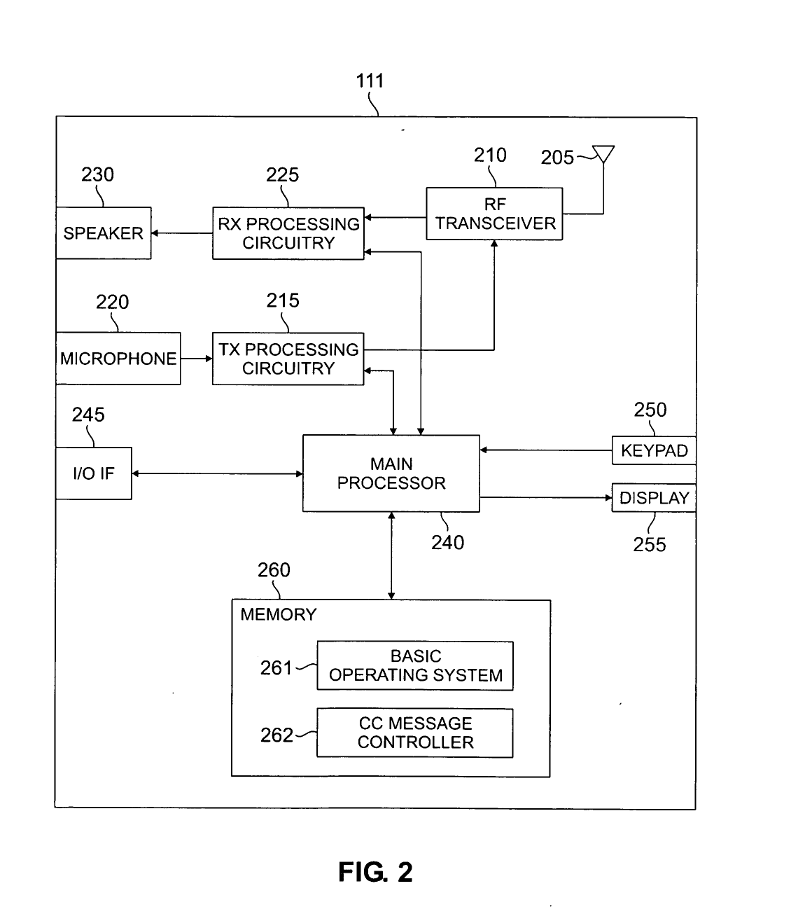

As described in more detail below in connection with FIG. 2, at least one of mobile stations 111-114 may comprise a hybrid mobile station that is capable of communicating in a voice mode and in a data mode. In addition, one or more of the base stations 101-103 may be capable of communicating with mobile stations 111-114 in either the voice mode or the data mode. These base stations may be referred to as hybrid base stations.

For a particular alternative, one or more of the base stations, such as base station 101a, may be capable of communicating with mobile stations 111-114 only in a voice mode, while one or more other base stations, such as base station 101b, may be capable of communicating with mobile stations 111-114 only in a data mode. For this embodiment, base station 101a may be referred to as a call session base station, while base station 101b may be referred to as a data session base station. It will be understood that any suitable combination of base stations may be implemented in wireless network 100 without departing from the scope of the present invention.

For the following description, base station 101a is a call session base station that operates in a CDMA2000 environment, such as 3G-1x, and base station 101b is a data session base station that operates in a High Rate Packet Data environment, such as 1xEV-DO. It will be understood that the description also applies to a hybrid base station that includes the functionality of both base stations 101a and 101b. In addition, mobile station 111 is assumed to be a hybrid mobile station.

In operation, according to an advantageous embodiment of the present invention, mobile station 111 is operating in a data mode and is communicating with data session base station 101b. MSC 140 receives an incoming voice call for mobile station 111. MSC 140 sends only one Paging Request in response to receiving the incoming voice call. The Paging Request is sent by MSC 140 to data session base station 101b. In response to the Paging Request, data session base station 101b pages mobile station 111, which acknowledges the page to data session base station 101b and switches from data mode to voice mode. Mobile station 111 also sends an Origination Message to call session base station 101a, which prompts call session base station 101a to set up the voice call previously received by MSC 140.

In this way, MSC 140 only has to send out one Paging Request, which eliminates superfluous paging messages. In addition, call session base station 101a and any hybrid base station may be implemented without needless additional complexity because these base stations may operate normally in these situations.

FIG. 2 illustrates an exemplary hybrid mobile station 111 that is capable of switching from a data mode to a voice mode in order to receive an incoming voice call according to the principles of the present invention. Mobile stations 112-114 may be identical to mobile station 111 and are not described separately. Wireless hybrid mobile station 111 comprises antenna 205, radio frequency (RF) transceiver 210, transmit (TX) processing circuitry 215, microphone 220, and receive (RX) processing circuitry 225. Hybrid mobile station 111 also comprises speaker 230, main processor 240, input/output (I/O) interface (IF) 245, keypad 250, display 255, and memory 260. Memory 260 further comprises basic operating system (OS) program 261 and control channel (CC) message controller application 262.

Radio frequency (RF) transceiver 210 receives from antenna 205 an incoming RF signal transmitted by a base station of wireless network 100. Radio frequency (RF) transceiver 210 down-converts the incoming RF signal to produce an intermediate frequency (IF) or a baseband signal. The IF or baseband signal is sent to receiver (RX) processing circuitry 225 that produces a processed baseband signal by filtering, decoding, and/or digitizing the baseband or IF signal. Receiver (RX) processing circuitry 225 transmits the processed baseband signal to speaker 230 (i.e., voice data) or to main processor 240 for further processing (e.g., web browsing).

Transmitter (TX) processing circuitry 215 receives analog or digital voice data from microphone 220 or other outgoing baseband data (e.g., web data, e-mail, interactive video game data) from main processor 240. Transmitter (TX) processing circuitry 215 encodes, multiplexes, and/or digitizes the outgoing baseband data to produce a processed baseband or IF signal. Radio frequency (RF) transceiver 210 receives the outgoing processed baseband or IF signal from transmitter (TX) processing circuitry 215. Radio frequency (RF) transceiver 210 up-converts the baseband or IF signal to a radio frequency (RF) signal that is transmitted via antenna 205.

In an advantageous embodiment of the present invention, main processor 240 is a microprocessor or microcontroller. Memory 260 is coupled to main processor 240. According to an advantageous embodiment of the present invention, part of memory 260 comprises a random access memory (RAM) and another part of memory 260 comprises a Flash memory, which acts as a read-only memory (ROM).

Main processor 240 executes basic operating system (OS) program 261 stored in memory 260 in order to control the overall operation of wireless hybrid mobile station 111. In one such operation, main processor 240 controls the reception of forward channel signals and the transmission of reverse channel signals by radio frequency (RF) transceiver 210, receiver (RX) processing circuitry 225, and transmitter (TX) processing circuitry 215, in accordance with well-known principles.

Main processor 240 also executes control channel (CC) message controller application 262. Control channel message controller application 262 is responsible for communicating with a base station in the common control channels and for setting up a call session while switching from a data mode to a voice mode according to the principles of the present invention. Thus, control channel message controller application 262 is capable of sending, in the voice mode, an Origination Message to call session base station 101a in response to a Paging Request received from data session base station 101b when mobile station 111 is in the data mode. The Origination Message results in the establishment of the voice call.

In an exemplary embodiment of the present invention, control channel message controller application 262 may be implemented as one of the functions of basic operating system program 261. However, for the purposes of clarity and simplicity in explaining the operation of the present invention, control channel message controller application 262 is shown in FIG. 2 as a separate entity from basic operating system program 261.

Main processor 240 is capable of executing other processes and programs resident in memory 260. Main processor 240 can move data into or out of memory 260, as required by an executing process. Main processor 240 is also coupled to I/O interface 245. I/O interface 245 provides hybrid mobile station 111 with the ability to connect to other devices such as laptop computers and handheld computers. I/O interface 245 is the communication path between these accessories and main controller 240.

Main processor 240 is also coupled to keypad 250 and display unit 255. The operator of hybrid mobile station 111 uses keypad 250 to enter data into hybrid mobile station 111. Display 255 may be a liquid crystal display capable of rendering text and/or at least limited graphics from web sites. Alternate embodiments may use other types of displays.

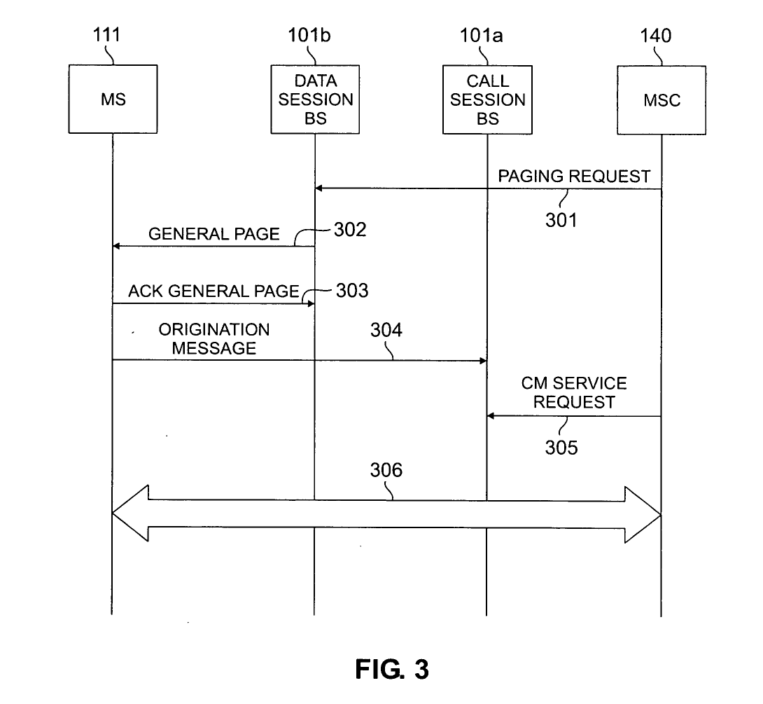

FIG. 3 is a flow diagram 300 illustrating a voice call set-up operation according to one embodiment of the present invention. For the following description, it is assumed that base station (BS) 101a is a call session base station and base station 101b is a data session base station. It is also assumed that hybrid mobile station (MS) 111 is initially accessing data session base station 101b in a data session and MSC 140 has received an incoming voice call for MS 111. It will be understood that the description also applies to a hybrid base station that includes the functionality of both base stations 101a and 101b.

In response to the incoming voice call, MSC 140 initiates the set-up of the voice call for MS 111 by transmitting a Paging Request message 301 to data session BS 101b. In response to Paging Request message 301, data session BS 101b transmits a General Page message 302 to MS 111 that notifies MS 111 of the incoming voice call. For one embodiment, General Page message 302 may comprise a CDMA2000 General Page message included in a 3 G-1 x services packet. In addition, General Page message 302 may or may not comprise information identifying the party that originally initiated the voice call, such as a telephone number.

In response to General Page message 302, MS 111 transmits an acknowledgement in the form of Acknowledgment (Ack) General Page message 303 to data session BS 101b and also transmits an Origination Message 304 to call session BS 101a. As previously described, data session BS 101b and call session BS 101a may or may not be the same base station. In addition, MS 111 may choose the call session BS to which Origination Message 304 is to be transmitted based on which call session BS is able to provide the best service for MS 111.

If General Page message 302 comprises information identifying the initiating party, Origination Message 304 may comprise that identifying information. Origination Message 304 may also comprise a preferred voice service option that is able to notify call session BS 101a that a voice call is being set up.

In response to receiving Origination Message 304 from MS 111, call session BS 101a transmits a Connection Management (CM) Service Request message 305 to MSC 140. If Origination Message 304 comprises information identifying the initiating party, CM Service Request message 305 may comprise that identifying information. If Origination Message 304 does not comprise the identifying information, CM Service Request message 305 may comprise a Special Service Call Indicator value that is able to indicate to MSC 140 that CM Service Request message 305 corresponds to a mobile-originated voice call without identifying information for the initiating party.

Based on CM Service Request message 305, MSC 140 recognizes that MS 111 is responding to the incoming voice call. At this point, MS 111, call session BS 101a, and MSC 140 may exchange additional messages 306 related to establishing the voice call. For one embodiment, the additional messages 306 may be in a TIA-2001 messaging format.

Although the present invention has been described with an exemplary embodiment, various changes and modifications may be suggested to one skilled in the art. It is intended that the present invention encompass such changes and modifications as fall within the scope of the appended claims.

What is claimed is:

1. A method for establishing a voice call for a hybrid mobile station that is initially operating in a data mode, comprising the steps of:
receiving an incoming voice call for the hybrid mobile station;
transmitting a single Paging Request message based on the incoming voice call;
receiving a Connection Management Service Request message; and
establishing the voice call for the hybrid mobile station based on the Connection Management Service Request.

2. The method as set forth in claim 1, where the step of transmitting the single Paging Request message based on the incoming voice call comprises the sub-step of transmitting the single Paging Request message to a data session base station, the hybrid mobile station initially accessing the data session base station in a data session.

3. The method as set forth in claim 2, wherein the data session base station is capable of operating in a High Rate Packet Data environment.

4. The method as set forth in claim 1, further comprising the step of refraining from transmitting messages to a call session base station before receiving the Connection Management Service Request message.

5. The method as set forth in claim 1, wherein the step of receiving the Connection Management Service Request message further comprises the step of receiving the Connection Management Service Request message from a call session base station and the step of establishing the voice call for the hybrid mobile station comprises the step of establishing the voice call for the hybrid mobile station through the call session base station.

6. The method as set forth in claim 5, wherein the call session base station comprises a hybrid base station, and the step of transmitting the single Paging Request message based on the incoming voice call comprises the step of transmitting the single Paging Request message to the hybrid base station, wherein the hybrid mobile station initially accesses the hybrid base station in a data session.

7. The method as set forth in claim 5, wherein the call session base station is capable of operating in a CDMA2000 environment.

8. A method for establishing a voice call for a hybrid mobile station that is initially operating in a data mode, comprising the steps of:
receiving a General Page message from a data session base station based on an incoming voice call; and
transmitting an Origination Message to a call session base station based on the General Page message, the Origination Message operable to prompt establishment of the voice call through the call session base station.

9. The method as set forth in claim 8, wherein the data session base station is capable of operating in a High Rate Packet Data environment.

10. The method as set forth in claim 8, wherein the call session base station is capable of operating in a CDMA2000 environment.

11. The method as set forth in claim 8, wherein the data session base station and the call session base station comprise a single hybrid base station, the hybrid base station capable of operating in a High Rate Packet Data environment for data sessions and capable of operating in a CDMA2000 environment for call sessions.

12. The method as set forth in claim 8, further comprising the step, after transmitting the Origination Message, of exchanging additional messages to establish the voice call with the call session base station and a mobile switching center.

13. The method as set forth in claim 8, further comprising the step of transmitting an Acknowledgment General Page message to the data session base station based on the General Page message.

14. The method as set forth in claim 8, wherein the General Page message is included in a 3 G-1 x services packet.

15. A hybrid mobile station that is operable to switch from a data mode to a voice mode, the hybrid mobile station comprising a control channel (CC) message controller application capable of receiving a General Page message from a data session base station based on an incoming voice call and transmitting an Origination Message to a call session base station based on the General Page message, wherein the Origination Message prompts establishment of the voice call through the call session base station.

16. The hybrid mobile station as set forth in claim 15, wherein the data session base station is capable of operating in a High Rate Packet Data environment.

17. The hybrid mobile station as set forth in claim 15, wherein the call session base station is capable of operating in a CDMA2000 environment.

18. The hybrid mobile station as set forth in claim 15, wherein the data session base station and the call session base station comprise a single hybrid base station, the hybrid base station capable of operating in a High Rate Packet Data environment for data sessions and capable of operating in a CDMA2000 environment for call sessions.

19. The hybrid mobile station as set forth in claim 15, wherein the CC message controller application is further capable, after transmitting the Origination Message, of exchanging additional messages for establishing the voice call with the call session base station and a mobile switching center.

20. The hybrid mobile station of claim 15, wherein the CC message controller application is further capable of transmitting an Acknowledgment General Page message to the data session base station based on the General Page message.
